(19) United States
(12) Patent Application Publication
(10) Pub. No.: US 2023/0175845 A1
(43) Pub. Date: Jun. 8, 2023

(54) Device and System for Aqueous Wave Measurement

(71) Applicant: Theodore Allen, Atlantic Beach, FL (US)

(72) Inventor: Theodore Allen, Atlantic Beach, FL (US)

(21) Appl. No.: 18/078,066

(22) Filed: Dec. 8, 2022

Related U.S. Application Data
(60) Provisional application No. 63/287,346, filed on Dec. 8, 2021.

(51) Int. Cl. G01C 13/00; B64C 39/02; B64U 20/80

(52) U.S. Cl. CPC G01C 13/004; B64C 39/024; B64U 20/80; B64U 2101/20

(57) ABSTRACT

The present disclosure provides for a device and system for aqueous wave measurement. The system may comprise at least one altimeter that may collect one or more measurements from a vertical orientation. The system may comprise at least one stabilization sensor that may interface with at least one positioning device. The stabilization sensor may, with fixed coordinates received from the positioning device, allow the drone to maintain a constant altitude above the variable, changing surface of water. The system may comprise one or more analytics that produce meaningful metrics from information received from the aqueous wave measurement device. The system may comprise at least one GUI that presents the analytics in an understandable way based on the expertise of a user viewing the analytics. The device may store collected measurements locally, or may transmit the measurements via at least one transmitting device, or both.

### CROSS-REFERENCE TO RELATED APPLICATION

This application is a Non-provisional of and claims priority to U.S. Provisional Patent Application Ser. No. 63/287,346 (filed Dec. 8, 2021, and titled “DEVICE AND SYSTEM FOR MARINE WAVE MEASUREMENT”), the entire contents of which are incorporated herein by reference.

### BACKGROUND

As early as the third or fourth millennium BC, people have had a need to create standardized forms of measurement. Originating out of the agricultural necessity for determining matters such as crop production and trade, most of the original forms of measurement were confined to a region and a particular field of use; dry grains were measured with different metrics than liquids, and both were measured with a metric independent of land measurements. As the world evolved and things such as electricity and manufacturing enabled trade from farther distances, a more standardized form of measurement was adopted.

As people began to build larger structures, measurements became more challenging. Measuring height become especially difficult for tall structures such as buildings. Using mathematical methods, tall objects could be calculated using a fixed point and a few known distances and angles. However, these measurement methods became impractical when applied to water-based scenarios. Measuring an ocean wave with this method became nearly impossible because not only were the only fixed points on the shore, but the entire wave was constantly moving and changing.

As technology has developed over time, images and videos of waves are now used for measurement. After the initial photo and video segments are captured, the footage is reviewed and measured using pixel ratio; that is, by using a fixed object in the frame and relative distances from that fixed object, distances within the image are converted to actual distances within the real world.

However, these solutions come with limitations. For example, images and video footage are often inconsistent and sparse. Additionally, the footage that can be measured requires using a complex set of conversions to make the footage a viable measurement tool. For instance, the angle of perspective between the fixed locations in captured images and video has to be accounted for, the image resolution and feed rate of video has to be taken into consideration, and the timing of the frames within the images has to be matched exactly, otherwise the amount of error in the measurement makes the measurement obtained from the image too unreliable for use.

### SUMMARY OF THE DISCLOSURE

What is needed are devices and systems for aqueous wave measurement that provide a consistently accurate measurement of aqueous environments. In some embodiments, devices and systems are needed that reduce the complexity and subjectivity of current measurement methods and decrease the probability that the measurements may contain significant amounts of error. In some embodiments, devices and systems are needed that may provide an accuracy of measurement derived from high precision measurement methods while facilitating simplicity in use that may be sufficient to avoid impracticality.

The present disclosure provides for devices and systems for aqueous wave measurement. In some implementations, an aqueous wave measurement system in accordance with the present disclosure may comprise at least one altimeter. In some aspects, the altimeter may be configured to collect one or more measurements from a vertical orientation. In some embodiments, the system may comprise at least one stabilization sensor. In some implementations, the stabilization sensor may interface with at least one positioning device. In some aspects, the stabilization sensor may use one or more fixed coordinates received from the positioning device to facilitate the maintenance of at least one drone at a constant altitude above a surface of water that may comprise a variable, continuously changing nature.

In some embodiments, the aqueous wave measurement system of the present disclosure may comprise one or more analytics that may produce meaningful metrics from information received from at least one height measurement device. In some implementations, the system may comprise at least one graphical user interface (GUI) that may be configured to present the analytics in an understandable way based on a level of expertise of a user viewing the analytics. In some aspects, an aqueous wave measurement device in accordance with the present disclosure may be configured to collect one or more measurements from one or more measurement locations. In some embodiments, the disclosed aqueous wave measurement device may be configured to store one or more collected measurements locally in at least one database integrated with or communicatively coupled to the at least one drone, or the collected measurements may be transmitted by at least one transmitting device to one or more remote storage locations, or both. In some implementations, the aqueous wave measurement device may comprise at least one drone. In some aspects, the drone may comprise one or more sensing devices for detecting, sensing, and/or calculating one or more measurements.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1A illustrates an exemplary aqueous wave measurement system, according to some embodiments of the present disclosure.

FIG. 1B illustrates an exemplary aqueous wave measurement system, according to some embodiments of the present disclosure.

FIG. 2 illustrates a drone for an exemplary aqueous wave measurement system, according to some embodiments of the present disclosure.

FIG. 3 illustrates an exemplary aqueous wave measurement system, according to some embodiments of the present disclosure.

FIG. 4 illustrates an exemplary aqueous wave measurement system, according to some embodiments of the present disclosure.

FIG. 5 illustrates analytics displayed on an exemplary GUI, according to some embodiments of the present disclosure.

FIG. 6A illustrates a GUI for an exemplary aqueous wave measurement system, according to some embodiments of the present disclosure.

FIG. 6B illustrates a GUI for an exemplary aqueous wave m measurement system, according to some embodiments of the present disclosure.

FIG. 7 illustrates a GUI for an exemplary aqueous wave measurement system, according to some embodiments of the present disclosure.

FIG. 8A illustrates a GUI for an exemplary aqueous wave measurement system, according to some embodiments of the present disclosure.

FIG. 8B illustrates a GUI for an exemplary aqueous wave measurement system, according to some embodiments of the present disclosure.

FIG. 9 illustrates exemplary method steps for an aqueous wave measurement process, according to some embodiments of the present disclosure.

### DETAILED DESCRIPTION

The present disclosure provides generally for systems and methods for aqueous wave measurement that provide consistently accurate measurements of one or more aspects of aqueous environments. In some aspects, the systems and methods of the present disclosure may reduce the complexity of current measurement methods and may decrease the probability that the obtained measurements may contain significant amounts of error. In some implementations, the systems and methods of the present disclosure may facilitate the calculation of one or more aqueous wave measurements directly from at least one aqueous wave by determining the difference between two or more linear measurements, thereby allowing the aqueous wave measurements to be calculated in a highly accurate manner with low complexity.

In the following sections, detailed descriptions of examples and methods of the disclosure will be given. The descriptions of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Wave spectrum: As used herein refers to one or more attributes that may be determined based upon a predetermined scale of characteristics. For example, the wave spectrum may comprise a wave energy spectrum which may comprise a power spectrum of wave elevation and wave frequency.

Aqueous wave: As used herein refers to any variability or disturbance in the surface of any body of water. By way of example and not limitation, an aqueous wave may comprise one or more waves that may traverse on ocean, lake, pond, or river surface.

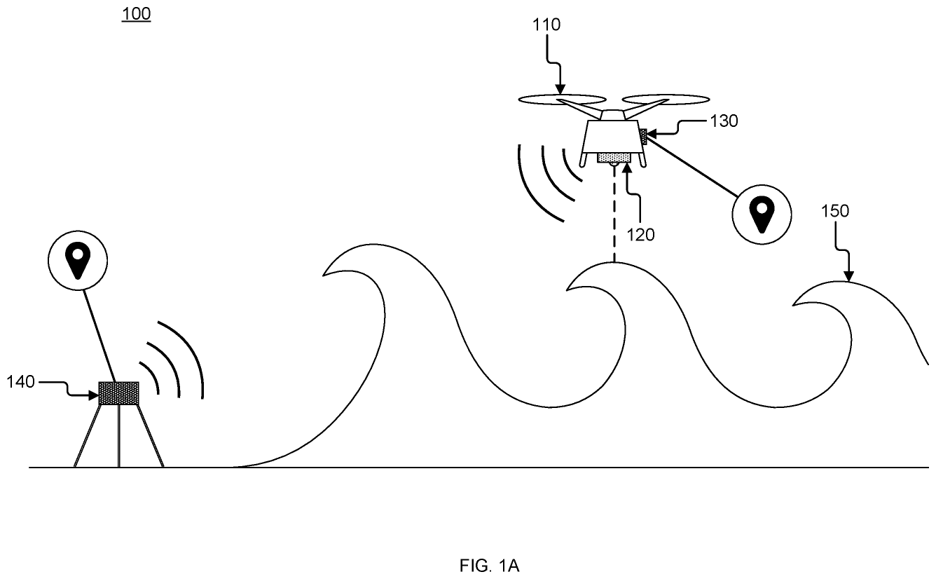

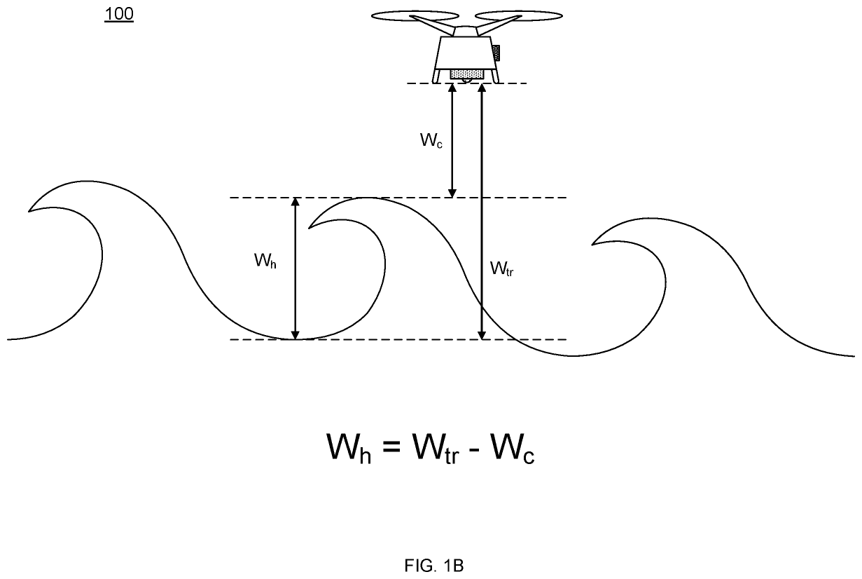

Referring now to FIG. 1A-B, an exemplary aqueous wave measurement system 100 is illustrated. In some embodiments, the aqueous wave measurement system 100 may comprise at least one drone 110. In some implementations, the drone 110 may comprise at least one altimeter 120. In some aspects, the drone 110 may comprise at least one stabilization sensor 130. In some embodiments, the aqueous wave measurement system 100 may interact with one or more waves 150. In some implementations, the aqueous wave measurement system 100 may comprise at least one positioning device 140.

In some aspects, the altimeter 120 may be configured to record one or more distance measurements from the drone 110 to a plurality of surfaces. For example, the drone 110 may hover or otherwise fly above at least one wave 150 and use the altimeter 120 to measure the distance from a base of the wave 150 to the drone 110 and a crest of the wave 150 to the drone 110. In some embodiments, the drone 110 may record this information on at least one removable storage device that may be uploaded manually or automatically to at least one communicatively coupled external server at another point in time. In some implementations, the drone 110 may comprise one or more memory resources with computational software that may comprise one or more analytics that may be sufficient to find the difference between the base and the crest or peak of the wave 150 to determine or calculate a height of the wave 150.

In some aspects, the measurements of the wave 150 calculated by the aqueous wave measurement system 100 comprise a high level of accuracy. For example, instead of measuring visual images that represent the movement and height of the waves 150, the aqueous wave measurement system 100 may physically measure one or more aspects of an actual wave 150, thereby reducing estimation error in wave 150 measurement.

In some embodiments, the aqueous wave measurement system 100 may comprise an altimeter 120 that may be configured to return at least one signal from the surface of at least one wave 150 without penetrating the surface of the relevant body of water. In some implementations, the altimeter 120 may be configured to measure the distance from the drone 110 to the base of the wave 150, or the crest of the wave 150, or both. In some aspects, the consistency of this form of measurement may comprise less subjectivity than current methods of wave 150 measurement.

In some aspects, the altimeter 120 may be configured to store one or more recorded measurements in at least one local or remote database for extraction to at least one analytics server at a later time. In some implementations, the at least one analytics server may be communicatively coupled to the at least one local or remote database, either wirelessly or via one or more wired connections, or the one or more recorded measurements may be extracted to the at least one analytics server via at least one removable storage device. For example, the altimeter 120 may record measurement data on a removable disc that may be inserted into at least one computing device after the drone 110 has finished measuring one or more waves 150.

In some embodiments, the drone 110 may comprise at least one transmitting device that may allow the altimeter 120 to transfer one or more measurements to at least one external device, such as, for example and not limitation, a desktop computing device, a laptop computing device, a tablet computing device, a smartphone, or any similar device. In some implementations, the drone 110 may comprise at least one controller communicatively coupled to one or more memory resources (such as, for example and not limitation, one or more databases), wherein the memory resource(s) comprise one or more instructions, or code, in the form of computational software that may be configured to receive measurement data from the altimeter 120 and produce or generate one or more desired metrics.

As an example, the altimeter 120 may calculate measurements from the drone 110 to the base of the wave 150 and from the drone 110 to the crest of the wave 150. While the altimeter 120 may traditionally be used in horizontal measurement applications, such as measuring distances for self-driving vehicles, the computational software may allow the altimeter 120 to calculate vertical measurements and find the difference between these two measurements to provide the height of the wave 150.

In some aspects, the computational software may produce or generate one or more desired metrics derived from one or more measurements detected by one or more sensing devices on the drone 110, such as the wave 150 height, the wave 150 period, the wave 150 speed, a wave 150 spectrum, chlorophyll levels in the body of water that a wave 150 traverses, and water surface temperature, as non-limiting examples.

In some embodiments, the computational software may operate on at least one external server. In some implementations, the computational software may comprise a plurality of analytics and/or filtering programs to process information received from the altimeter 120. For example, the computational software may comprise high-pass filtering to reduce noise in the data received from the altimeter 120.

In some aspects, the data received from the altimeter 120 may be averaged over one or more predetermined periods of time to reduce the number of computed data points used in the measurement analysis. In some embodiments, averaging data from the altimeter 120 may decrease the amount of time and hardware resources required to compute the desired metrics when the resolution or frequency of measurement is more than required for the desired metrics.

In some implementations, the drone 110 may interface with a positioning device 140 to maintain a substantially constant altitude. In some aspects, a rangefinder, a device that typically maintains a predetermined height for a drone 110 by measuring the distance to the ground or other solid surface, may be deactivated due to the variable surface of the water comprising one or more waves 150. A constantly changing variable surface of the water may cause the rangefinder to determine that the height of the drone 110 above the water surface is constantly changing, thereby preventing the rangefinder from maintaining a constant altitude for the drone 110. In some embodiments, the rangefinder may assist the altimeter 120 in verifying the height of the waves 150. In some implementations, the drone 110 comprise a stabilization sensor 130 that may interface with a positioning device 140.

In some aspects, the positioning device 140 may be located on the shore or other land-based location. In some embodiments, the positioning device 140 may be configured to transmit positional feedback to the stabilization sensor 130 to assist the drone 110 in maintaining a substantially constant altitude while measuring the height of the waves 150. For example, a positioning device 140 in the form of a real-time kinematic (RTK) Global Positioning System (GPS) receiver on a tripod may provide a constant height for the drone 110 in lieu of using a standard rangefinder.

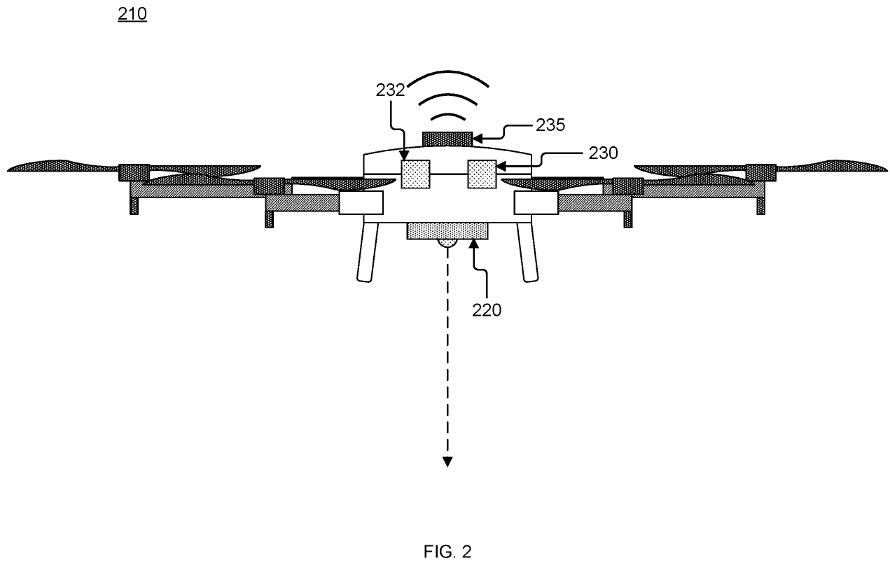

Referring now to FIG. 2, a drone 210 for an exemplary aqueous wave measurement system 200 is illustrated. In some aspects, the drone 210 may comprise at least one altimeter 220. In some embodiments, the drone 210 may comprise at least one stabilization sensor 230. In some implementations, the drone 210 may comprise at least one transmitting device 235. In some aspects, the drone 210 may comprise one or more sensing devices 232.

In some aspects, the altimeter 220 may be configured to record one or more distances from the drone 210 to one or more surfaces. For example, the drone 210 may hover or otherwise fly above at least one wave and use the altimeter 220 to measure, for example and not limitation, the distance from the base of the wave to the drone 210 and the crest of the wave to the drone 210. In some embodiments, the aqueous wave measurement system 200 may comprise an altimeter 220 that may be configured to return at least one signal from the surface of the wave without penetrating the surface of the relevant body of water. In some implementations, the altimeter 220 may be configured to measure the distance from the drone 210 to the base of the wave, or the crest of the wave, or both.

In some aspects, the measurements of the wave by the aqueous wave measurement system 200 may comprise a high level of accuracy. For example, instead of measuring visual images that represent the movement and height of ten or more waves, the aqueous wave measurement system 200 may physically measure one or more actual waves, thereby reducing estimation error in wave measurement. In some implementations, the measurements may be transmitted in substantially real-time for use in assessing various sport feats.

As an illustrative example, big wave competitions may display the wave height and other measurements collected from the altimeter 220 to provide an informative overlay that may inform a viewer of the height of a current surfer's wave, as well as wave speed or other non-limiting wave attributes.

As another example, general surf competitions may display the wave height and other measurements collected from the altimeter 220 to provide an informative overlay that may inform one or more competition judges of the height of a current surfer's wave, as well as wave speed or other non-limiting wave attributes. The consistent measurements provided by the altimeter 220 may provide accurate measurements with little to no subjective bias and/or rounding error. This wave information may be particularly desirable, for example and not limitation, for evaluating high performance surf spots on the World Surf League world tour.

In some embodiments, the drone 210 may comprise a transmitting device 235 that may allow the altimeter 220 to transfer one or more calculated, determined, or obtained measurements to at least one external device. In some implementations, the drone 210 may comprise one or more instructions, or code, in the form of computational software that may be configured to receive measurement data from the altimeter 220 and produce or generate one or more predetermined metrics.

As an example, the altimeter 220 may provide measurements from the drone 210 to the base of a wave and from the drone 210 to the crest of a wave. The computational software may be configured to determine the difference between these two measurements to provide a height of the wave. In some embodiments, the stabilization sensor 230 may be configured to interact with at least one positioning device, wherein the positioning device may establish a determined known height.

In some aspects, the aqueous wave measurement system 200 may comprise one or more sensing devices 232 that may detect one or more measurements to obtain an amount of measurement data that allows the computational software to compare the known height from the positioning device with the drone's 210 current height above the relevant aqueous surface that comprises one or more waves to be measured, as at least partially determined by the computational software using the measurement data from the sensing device(s) 232, to enable the computational software to determine whether the drone 210 is experiencing any undesirable or unintentional vertical movement.

In some implementations, the computational software of the aqueous wave measurement system 200 may be configured to use the known height provided by the positioning device and the current height of the drone 210 above the aqueous surface to calculate a wave height using fewer measurements from the altimeter 220, to adjust the wave height measurement to compensate for any unintentional vertical drift being experienced by the drone 210, or to adjust the current height of the drone 210 above the aqueous surface to minimize unintentional vertical movement, as non-limiting examples.

In some aspects, the computational software may be configured to produce, determine, calculate, or generate one or more desired metrics correlated to one or more measurements obtained by one or more sensing devices 232 on the drone 210, such as, for example and not limitation, the wave height, the wave period, the wave speed, a wave spectrum, chlorophyll levels in the body of water associated with a wave, and water surface temperature, as non-limiting examples.

In some embodiments, the drone 210 may comprise a plurality of sensing devices 232. In some implementations, the drone 210 may assist in one or more various marine monitoring efforts. In some aspects, the drone 210 may comprise sensing devices 232 that allow the aqueous wave measurement system 200 to measure thermal levels for water surface temperature. Water surface temperature may comprise a critical parameter in weather prediction, atmospheric model simulations, and the study of marine ecosystems, as non-limiting examples. In some embodiments, the drone 210 may comprise at least one radar-based sensing device 232 or at least one lidar-based (light detection and ranging) sensing device 232. As a non-limiting example, the drone may utilize a radar sensing device or pulsed lidar rangefinder sensing device to determine the location of at least one surface or object relative to the drone 210.

In some embodiments, the drone 210 may comprise at least one bio-reflectance sensing device 232 for productivity or at lease one pole-based anemometer for wind speed measurements, as non-limiting examples. In some implementations, one or more of the sensing devices 232 may, in addition to wave measuring capabilities, provide the aqueous wave measurement system 200 with one or more additional capacities that may provide value to port managers, coastal zone managers, universities, research vessels, and shipping vessels, as non-limiting examples. For instance, by way of example and not limitation, port managers may use wave height and wave speed information to determine optimal times for ship entry or departure.

In some aspects, the drone 210 may comprise at least one communication device for interacting with one or more users in the vicinity of the aqueous wave measurement system 200. For example, the drone 210 may comprise at least one two-way microphone that may allow the aqueous wave measurement system 200 to facilitate interviews with one or more surfers in the water during surf competitions. In some embodiments, the communication device may comprise one or more safety features such as a speaker or other audio-emitting device that may warn individuals of shark siting locations, as a non-limiting example.

As an example, a surfer may fall while surfing and the aqueous wave measurement system 200 may detect and report the location of the surfer. A communication device within the aqueous wave measurement system 200 may enable first-responders to assess the surfer's condition and maintain contact with the surfer while help is en route. In some embodiments, a surfer may wear at least one transmitter device while in the water to maintain contact with the drone 210 until help arrives.

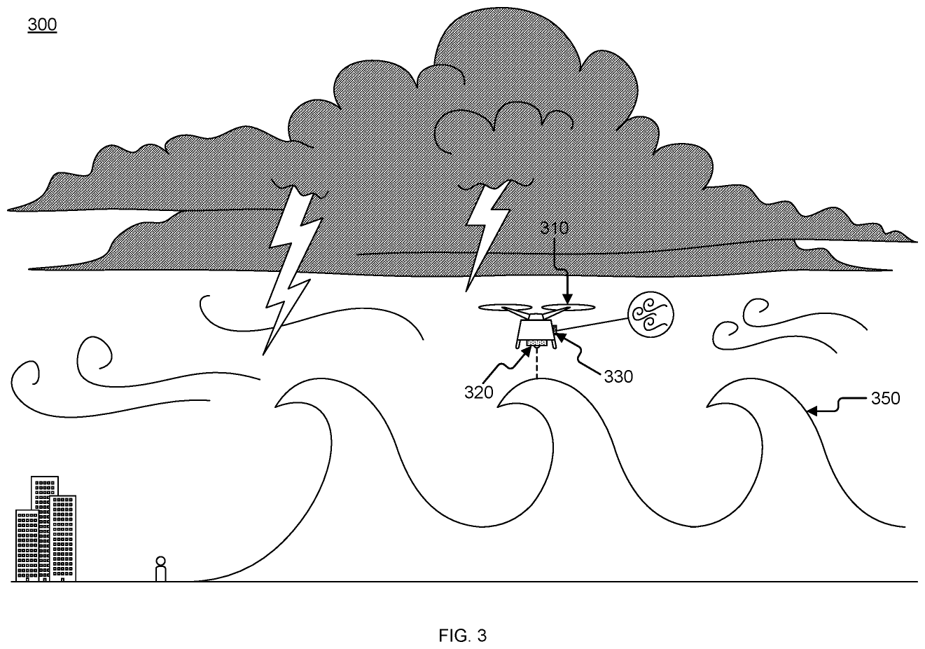

Referring now to FIG. 3, an exemplary aqueous wave measurement system 300 is illustrated. In some embodiments, the aqueous wave measurement system 300 may comprise at least one drone 310. In some implementations, the drone 310 may comprise at least one altimeter 320. In some aspects, the drone 310 may comprise at least one wind sensor 330. In some embodiments, the aqueous wave measurement system 300 may be configured to interact with one or more waves 350. In some implementations, the aqueous wave measurement system 300 may comprise at least one positioning device.

In some embodiments, the drone 310 may comprise at least one radar-based sensing device and/or at least one lidar-based sensing device. In some implementations, data received from the radar-based sensing device may be fused with data received from the lidar-based sensing device. In some aspects, this fusion of data may improve the accuracy and/or reduce the uncertainty of measurements, calculation, or determinations made by the aqueous wave measurement system 300. By way of example and not limitation, data from the radar-based sensing device may be fused with data from the lidar-based sensing device using an extended Kalman filter.

In some embodiments, the drone 310 may comprise at least one wind sensor 330 for facilitating the calculation or determination of one or more wind speed measurements. In some aspects, the wind sensor 330 may comprise a pole-based anemometer, manometer, or pitot tube, as non-limiting examples. In some implementations, the drone 310 may comprise one or more sensors that may, in addition to wave measuring capabilities, provide the aqueous wave measurement system 300 with one or more additional capacities that may provide value to port managers, coastal zone managers, universities, research vessels, and shipping vessels, as non-limiting examples.

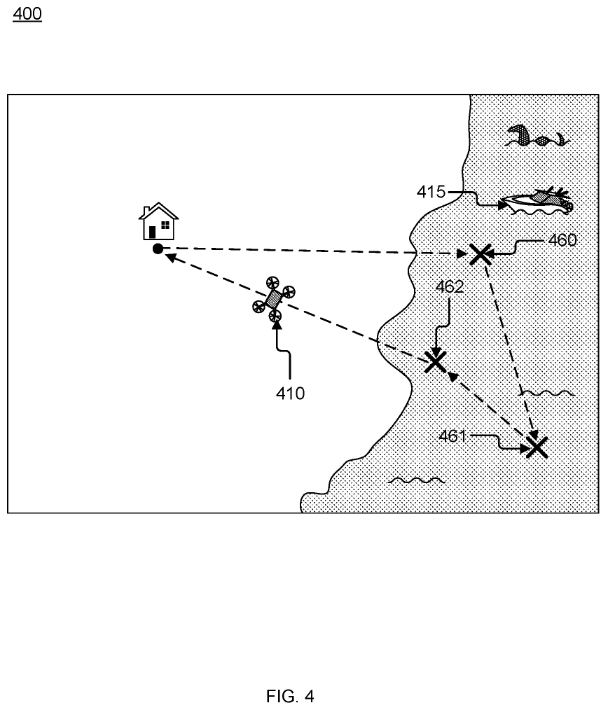

Referring now to FIG. 4, an exemplary aqueous wave measurement system 400 is illustrated. In some embodiments, the aqueous wave measurement system 400 may comprise at least one drone 410. In some implementations, the aqueous wave measurement system 400 may measure one or more measurement locations 460, 461, 462.

For example, a wave forecaster may use the aqueous wave measurement system 400 to conduct cyclical measurements of waves at predetermined locations along a coastline to compare actual wave height data received from the aqueous wave measurement system 400 to wave height estimates generated by one or more computer models to assess the accuracy of the model(s). As another example, a surfer may use the aqueous wave measurement system 400 to evaluate substantially real-time conditions of one or more waves to decide whether surfing at a predetermined location is preferable to one or more other surfing locations. As another non-limiting example, a surfer or wave forecaster may use the aqueous wave measurement system 400 to determine locations of one or more ships or boats 415.

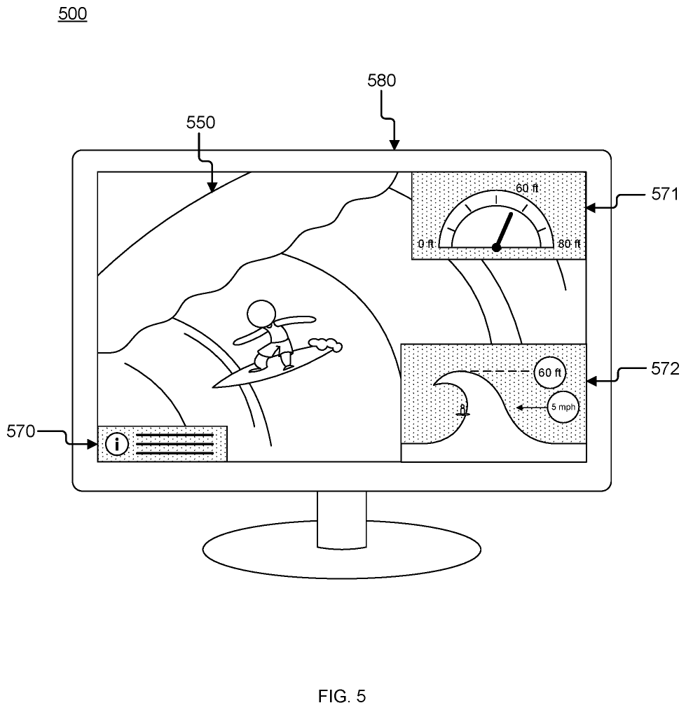

Referring now to FIG. 5, analytics 570, 571, 572 displayed on an exemplary GUI 590 is illustrated. In some embodiments, the GUI 590 may comprise at least one visual depiction of at least one wave 550. In some implementations, the GUI 590 may present the analytics 570, 571, 572 or at least one external device 580.

In some embodiments, the GUI 590 may comprise an overlay to another interface. For example, the GUI 590 may display analytics 570, 571, 572 related to a live sport performance, such as the height of a wave 550, the speed of a wave 550, or the comparative height of a current wave 550 relative to previous waves 550, as non-limiting examples. In some implementations, the analytics 570 may provide informative insights into the current status of a measured wave 550. In some embodiments, the informative insights may comprise statistical performance information about one or more performers, such as previous surf competition performances of a current surfer, as a non-limiting example.

In some aspects, the analytics 572 may provide alternative views of a live performance, such as a zoomed out or expanded view of a present performance, as a non-limiting example. In some embodiments, the analytics 571 may provide comparisons between waves 550 currently measured and information about previously measured waves 550 stored within the aqueous wave measurement system 500.

As an illustrative example, big wave competitions may display the wave height and other measurements collected from an altimeter on a drone to provide an informative overlay that may inform one or more viewers of the height of a current surfer's wave 550, as well as wave 550 speed and other non-limiting wave 550 attributes. In some implementations, these measurements may be used to gauge competition rankings and provide estimates on projected winners of competitions. In some aspects, these measurements may minimize the subjectivity of aqueous wave 550 measurements and may decrease the margin of error in wave 550 height calculations.

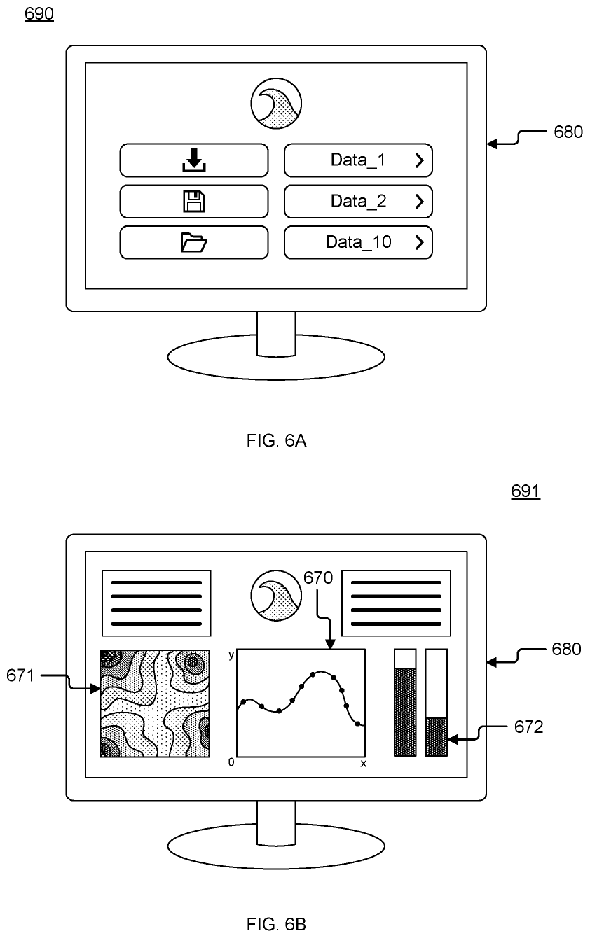

Referring now to FIG. 6A-B, a GUI 690, 691 for an exemplary aqueous wave measurement system is illustrated. In some embodiments, the GUI 690, 691 may interface with at least one external device 680. In some implementations, the GUI 690, 691 may comprise one or more analytics 670, 671, 672.

In some aspects, the GUI 690 may allow one or more users to import external data for analysis. As an example, a marine researcher may collect one or more raw wave data from at least one force sensor located on the ocean floor. In some embodiments, the raw wave data may be uploaded to the GUI 690 and may receive the same data analysis. In some implementations, the GUI 690 may allow the user to save, export, and open data files, as non-limiting options, from one or more sources. In some aspects, the GUI 690 may enable the user to save analytics 670, 671, 672 from the loaded data.

In some implementations, the GUI 691 may display the difference between two or more measurements to provide the height of the wave. In some aspects, the GUI 691 may produce desired analytics 670, 672 correlated to sensors on the drone such as the wave height, the wave period, the wave speed, a wave spectrum, and chlorophyll levels in the water, as non-limiting examples.

In some aspects, the GUI 691 may form graphical displays that aggregate collected data into meaningful analytics 671. For example, the aqueous wave measurement system may measure thermal levels for sea surface temperature. Sea surface temperature is a critical parameter in weather prediction, atmospheric model simulations, and the study of marine ecosystems. In some embodiments, the GUI 691 may use the collected thermal levels to generate at least one heat map of the measured region to depict trends and gradients in the surface temperature, as a non-limiting example

In some implementations, the GUI 691 may generate a frequency-based heat map to show trends in other wave attributes such as wave frequency, locations with the largest consistent waves, and other non-limiting examples. In some embodiments, the GUI 691 may store data from previous measurements. In some aspects, the heat maps may use stored previous data to display trends on a predetermined frequency such as over a week, over a month, or in real-time, as non-limiting options.

In some embodiments, the GUI 691 may operate on at least one external server. In some implementations, the GUI 691 may comprise filtering to process information received from the aqueous wave measurement system. For example, the GUI 691 may comprise high pass filtering to reduce noise in the data received from the altimeter.

In some aspects, the data may be averaged over predetermined periods of time to reduce the number of computed data points in the measurement analytics 670. In some embodiments, averaging data from the altimeter may decrease the time and hardware resources required to compute the desired analytics 670 when the resolution or frequency of measurement is more than required for the desired metrics.

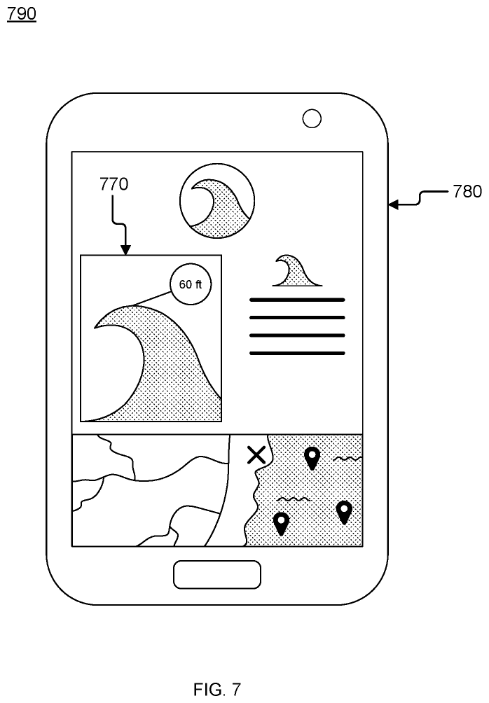

Referring now to FIG. 7, a GUI 790 for an exemplary aqueous wave measurement system is illustrated. In some embodiments, the GUI 790 may interface with at least one external device 780. In some implementations, the GUI 790 may comprise one or more analytics 770.

In some aspects, the GUI 790 may form graphical displays that aggregate collected data into meaningful analytics 770. For example, the aqueous wave measurement system may provide a visual representation of wave height for one or more locations. In some embodiments, the GUI 790 may comprise a representation of all measurements received from a plurality of locations, such as a map.

As an example, selection of a location on a map of received measurements may display the wave height as well as the average wave speed, the average wave height, and the current forecasted surfing conditions. In some implementations, the GUI 790 may be accessed on a portable external device 780, such as a smartphone. In some aspects, the GUI 790 may comprise summarized analytics 770 designed to provide information relevant to novice audiences. As an example, an amateur surfer may arrive at a beach and use the GUI 790 to assess swells of the waves in three locations in close proximity to determine which location is optimal for surfing under the current conditions.

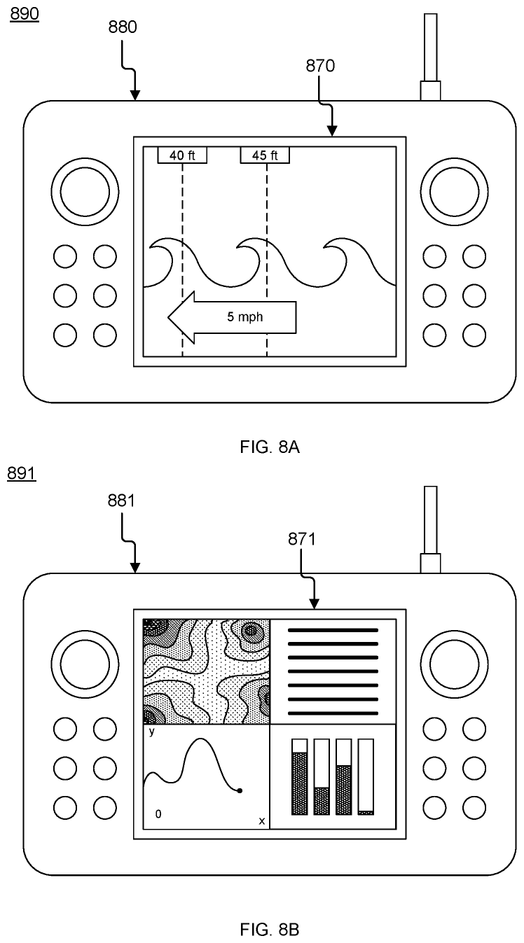

Referring now to FIG. 8A-B, a GUI 890 for an exemplary aqueous wave measurement system is illustrated. In some embodiments, the GUI 890 may interface with at least one external device 880. In some implementations, the GUI 890 may comprise one or more analytics 870.

In some embodiments, at least one user may interface with the GUI 890 as they operate the aqueous wave measurement system. In some implementations, the at least one user may operate the aqueous wave measurement system while searching for predetermined conditions. In some aspects, the at least one user may review real-time analytics via the GUI 890 to determine whether a measured location meets the required predetermined conditions.

As an illustrative example, a marine scientist may search for probable ecosystems for an organism that requires the water to contain chlorophyll levels within a predetermined range of values. The scientist may use one or more sensing devices associated with the aqueous wave measurement system to verify the chlorophyll levels at least one predetermined location in a body of water until the scientist finds a location that meets the requisite quantity of chlorophyll. The scientist may further use the analytics to assess additional ecological factors simultaneously to further investigate the efficacy of the water as a viable ecosystem. The scientist may, while reviewing chlorophyll levels in real-time, assess the water surface temperature, turbulency, vorticity in current flow, and other non-limiting examples of characteristics.

As another illustrative example, a civil engineer may use the aqueous wave measurement system to search for viable locations for a new marina. In reviewing potential locations, the engineer may use the analytics to assess a location's wave height history. Prior to reviewing potential sites, the engineer may program the drone to take daily wave height measurements for several months at potential marina locations to review wave height averages over lengthier periods of time. The engineer may review analytics displayed on the GUI embedded in the drone controller to get real-time measurements of potential marina locations.

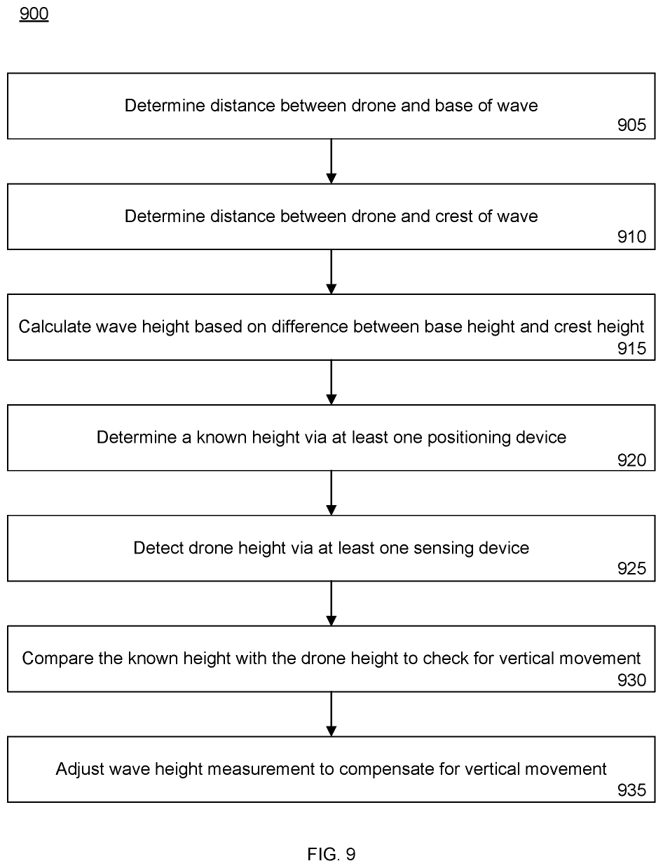

Referring now to FIG. 9, exemplary method steps for an aqueous wave measurement process, are illustrated. In some aspects, at 905, at least one altimeter of at least one drone may measure or otherwise determine the distance between the drone and the base of a wave traversing an aqueous surface. In some implementations, at 910, the at least one altimeter of the at least one drone may measure or otherwise determine the distance from the drone to the crest of the wave. In some embodiments, at 915, one or more instructions in the form of computational software stored within one or more memory resources of the at least one drone may calculate the difference between the distance from the drone to the base of the wave and the distance between the drone and the crest of the wave to determine a height of the at least one wave.

In some aspects, at 920, at least one positioning device may determine a known height. In some embodiments, the positioning device may comprise one or more GPS receivers and/or transmitters. In some implementations, at 925, at least one sensing device of the at least one drone may detect the height of the drone above the aqueous surface. In some aspects, at 930, the computational software may compare the known height determined by the positioning device with the detected height of the drone to determine whether the drone is experiencing any unintentional vertical movement above the aqueous surface. In some non-limiting exemplary embodiments, at 935, the computational software of the drone may compensate for any unintentional vertical movement when determining the height of the at least one wave by adjusting the measurement of the height of the at least one wave to reflect the amount of unintentional movement of the drone. In some aspects, the computational software of the drone may control one or more mechanisms of the drone, such as one or more propellers of the drone, to adjust the height of the drone in response to a determination that the drone has experienced unintentional vertical movement in one or more directions.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A system for aqueous wave measurement comprising:
at least one drone comprising:
at least one stabilization sensor,
at least one transmitting device configured to transmit one or more measurements to at least one external device,
at least one altimeter configured to record one or more distance measurements from the drone to a plurality of surfaces; and
one or more memory resources, wherein the one or more memory resources comprise one or more instructions in the form of computational software configured to receive measurement data from the at least one altimeter and generate one or more metrics based on the received measurement data; and
at least one positioning device configured to
transmit positional feedback to the at least one stabilization sensor.

2. The system for aqueous wave measurement of claim 1, wherein the at least one altimeter is further configured to:
return at least one signal from a surface of at least one wave,
measure a distance from the at least one drone to a base of the at least one wave, and
measure a distance from the at least one drone to a crest of the at least one wave.

3. The system for aqueous wave measurement of claim 2, wherein the system further comprises at least one local or remote database, wherein the at least one altimeter is further configured to store one or more recorded measurements in the at least one local or remote database.

4. The system for aqueous wave measurement of claim 3, wherein the system further comprises at least one analytics server, wherein the one or more recorded measurements are extracted to the at least one analytics server.

5. The system for aqueous wave measurement of claim 1, wherein the computational software is further configured to operate on at least on external server.

6. The system for aqueous wave measurement of claim 2, wherein the computational software is further configured to calculate a difference between the distance from the at least one drone to the base of the at least one wave and the distance between the at least one drone and the crest of the at least one wave to determine a height of the at least one wave.

7. The system for aqueous wave measurement of claim 1, wherein the at least one drone further comprises at least one sensing device, wherein the at least one sensing device is configured to detect one or more measurements.

8. The system for aqueous wave measurements of claim 7, wherein the at least one positioning device is configured to determine a known height, wherein the computational software is further configured to compare the known height with a current height of the at least one drone to determine whether the at least one drone is experiencing any unintentional vertical movement, wherein the current height of the at least one drone is at least partially determined from the one or more measurements detected by the at least on sensing device.

9. The system for aqueous wave measurement of claim 7, wherein the at least one sensing device comprises at least one of: a radar-based sensing device and a lidar-based sensing device.

10. The system for aqueous wave measurement of claim 7, wherein he at least one sensing device comprises at least one radar-based sensing device and at least one lidar-based sensing device, wherein data received from the radar-based sensing device is fused with data received from the lidar-based sensing device.

11. The system for aqueous wave measurement of claim 1, wherein the at least one drone further comprises at least one communication device, wherein the at least one communication device comprises at least one audio-emitting device.

12. The system for aqueous wave measurement of claim 7, wherein the at least one sensing device is configured to detect one or more measurements that enable the computational software to generate one or more additional metrics that comprise one or more of; a wave height, a wave period, a wave speed, a wave spectrum, or a chlorophyll level in an amount of water associated with the at least one wave.

13. A device for aqueous wave measurement comprising
at least one drone comprising:
at least one stabilization sensor;
at least one transmitting device configured to transmit one or more measurements to at least one external device;
at least one altimeter configured to record one or more distance measurements from the drone to a plurality of surfaces; and
one or more memory resources, wherein the one or more memory resources comprise one or more instructions in the form of computational software configured to receive measurement data from the at least one altimeter and generate one or more metrics based on the received measurement data.

14. The device for aqueous wave measurement of claim 13, wherein the at least one altimeter is further configured to:
return at least one signal from a surface of at least one wave,
measure a distance from the at least one drone to a base of the at least one wave, and
measure a distance from the at least one drone to a crest of the at least one wave.

15. The device for aqueous wave measurement of claim 14, wherein the computational software is further configured to calculate a difference between the distance from the at least one drone to the base of the at least one wave and the distance between the at least one drone and the crest of the at least one wave to determine a height of the at least one wave.

16. The device for aqueous wave measurement of claim 13, wherein the at least one drone further comprises at least one sensing device, wherein the at least one sensing device is configured to detect one or more measurements.

17. The device for aqueous wave measurements of claim 13, wherein the at least one drone further comprises at least one communication device, wherein the at least one communication device comprises at least one audio-emitting device.

18. A method for aqueous wave measurement, the method comprising:
determining, via at least one altimeter of at least one drone, a distance from the at least one drone to a base of at least one wave;
determining, via the at least one altimeter of the at least one drone, a distance from the at least one drone to a crest or the at least one wave; and
calculating, via one or more instructions in the form of computational software stored within one or more memory resources of the at least one drone, a difference between the distance from the at least one drone to the base of the at least one wave and the distance between the at least one drone and the crest of the at least one wave to determine a height of the at least one wave.

19. The method for aqueous wave measurements of claim 18, wherein the method further comprises:
determining a known height via at least one positioning device; and
detecting, via at least one sensing device of the at least one drone, a height of the at least one drone above an aqueous surface.

20. The method for aqueous wave measurement of claim 19, wherein the method further comprises:
comparing, via the computational software, the known height with the height of the at least one drone to determine whether the at least one drone is experiencing any unintentional vertical movement.
